(19) United States
(12) Patent Application Publication
(10) Pub. No.: US 2007/0035739 A1
(43) Pub. Date: Feb. 15, 2007

(54) Portable electronic device with changeable color and method for manufacturing the same

(75) Inventor: Tsai-Shih Tung, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Chen City (TW)

(21) Appl. No.: 11/438,015

(22) Filed: May 19, 2006

(30) Foreign Application Priority Data
Jul. 29, 2005 (CN) 200510036288.9

(51) Int. Cl. G01N 21/55

(52) U.S. Cl. 356/445

(57) ABSTRACT

An exemplary portable electronic device (10) includes a frame (13). A color changing layer (20) contains a color-changeable material and is coated onto the frame. The portable electronic device utilizes the color changing layer to change colors, thereby achieving a color-change function of the portable electronic device. A method of manufacturing the portable electronic device is also included.

### TECHNICAL FIELD

The present invention generally relates to portable electronic devices and, more particularly, to a portable electronic device with changeable color and also relates to a method for manufacturing such a device.

### BACKGROUND

With the development of wireless communication and information processing technologies, portable electronic devices such as mobile phones and personal digital assistants (PDAs) are now in widespread use. These electronic devices enable consumers to enjoy high technology services anytime and anywhere. In addition, at present many manufacturers make multifunctional portable electronic devices such as mobile telephones incorporating cameras, thus creating even greater demand for more flexible technologies.

In addition to the special features mentioned above, the appearance of a portable electronic device is also an important factor in its marketability. A mobile phone with a pretty shape and eye-catching color-scheme is more attractive to consumers than the traditional black/white box-shaped design. At present, people can swap frames and thus change colors to fit their fancies. However, the color of the frames generally cannot change themselves and consumers must change colors of the portable electronic devices, if they wish, by changing the frames thereof. This is too awkward for most consumers and is also rather expensive.

Therefore, it is necessary to provide an improved portable electronic device with changeable color.

### SUMMARY

In one aspect, a portable electronic device is provided. The portable electronic device includes a frame. A color changing layer contains a color-changeable material and is coated onto the frame.

In another aspect of the preferred embodiment, a method of manufacturing the portable electronic device is provided.

Other novel features will become more apparent from the following detailed description, when taken in conjunction with the accompanying drawings.

### BRIEF DESCRIPTION OF THE DRAWINGS

Many aspects of the portable electronic device can be better understood with reference to the following drawings. The components in the drawings are not necessarily drawn to scale, the emphasis instead being placed upon clearly illustrating the principles of the present portable electronic device. Moreover, in the drawings, like reference numerals designate corresponding parts throughout the several views.

FIG. 1 is an assembled isometric view of a mobile phone incorporating a multilayer structure in accordance with a first embodiment;

FIG. 2 is a schematic view of the multilayer structure shown in FIG. 1;

FIG. 3 is a schematic view of a container; and

FIG. 4 is a schematic view of a multilayer structure in accordance with a second embodiment.

### DETAILED DESCRIPTION OF THE EMBODIMENTS

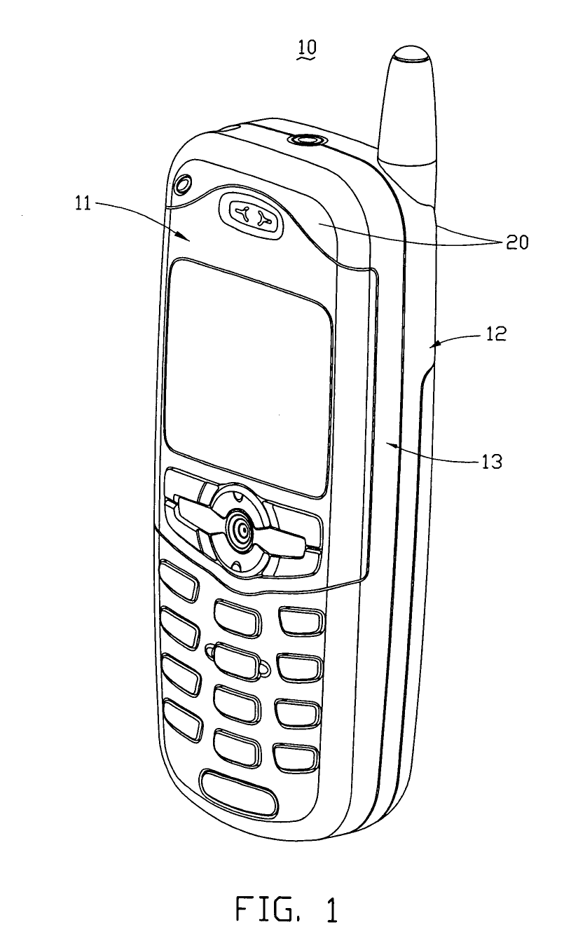

Referring now to the drawings in detail, FIG. 1 shows a mobile phone/portable electronic device 10 according to a first embodiment of the present portable electronic device with changeable color. The mobile phone 10 is taken here as an exemplary application. In alternative embodiments, the mobile phone 10 could be replaced by another portable electronic device, for example a PDA. The mobile phone 10 includes a frame 13 with a front cover 11 and a rear cover 12. A multilayer structure 20 which is color-changeable is coated onto the front cover 11 and the rear cover 12, so as to allow color-change of the front cover 11 and the rear cover 12.

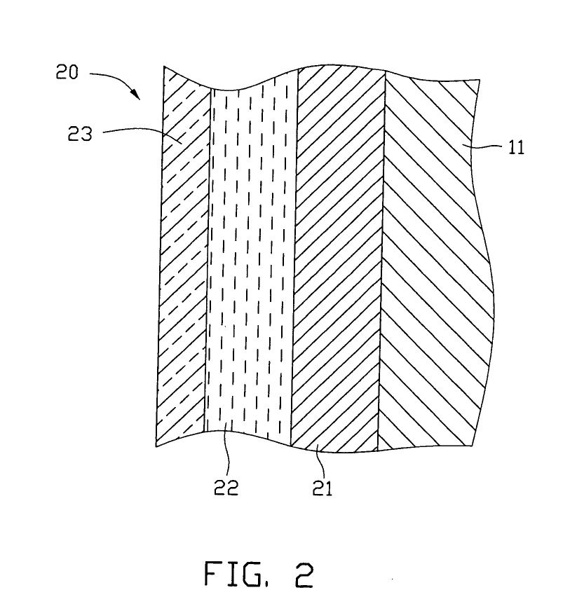

Referring to FIG. 2, the multilayer structure 20 includes a primer layer 21, a color changing layer 22, and a surface paint layer 23 stacked one on top of another in that order. The surface paint layer 23 is transparent and colorless, for enhancing luster and brightness of an outer surface of the mobile phone 10. The color changing layer 22 contains a color-changeable material, which is liquid and allows light to be transmitted therethrough, so that the color of the front cover 11 and the rear cover 12 is produced cooperatively by the primer layer 21 and the color changing layer 22. A color of the frame 13 of the mobile phone 10 not coated with the color changing layer 22 will be the color of the primer layer 21.

The color-changeable material may be either thermochromic or photochromic material. When the color-changeable material is a thermochromic material, the color changing layer 22 changes color within a temperature range, for example, from about 0 to about 40 degrees. The color changing layer 22 can change with a depth change within one color or be changed from one color to a different color by a temperature change. Thus the user can tell the ambient temperature by the color of the front cover 11 and the rear cover 12.

When the color-changeable material is a photochromic material, the color changing layer 22 changes color by absorbing sunlight. Each photochromic material absorbs light at certain wavelengths whilst reflecting others, thus allowing it to appear a certain color. For example, a kind of photochromic material absorbs yellow light, thus the color changing layer 22 appears blue color. The color changing layer 22 can change color-depth within one color or change from one color to a different color according to a change in the intensity of incident light. This allows the user to know the local light intensity by the color of the front cover 11 and of the rear cover 12.

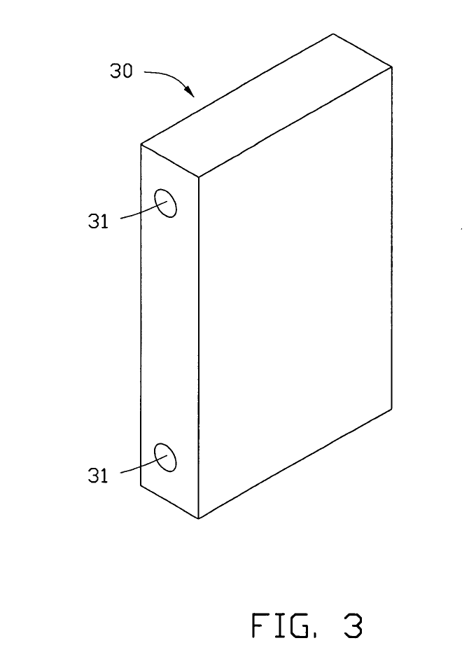

Referring also to FIG. 3, a method of manufacturing the mobile phone 10 with changeable color includes the following steps. Firstly, primer is put into a spray gun. The spray gun sprays the primer over the mobile phone 10. The primer of the mobile phone 10 is hardened by using, for example, heat treatment hardening or ultra-violet (UV) hardening, thereby forming the primer layer 21. A color-changeable material, for example, a thermochromic material or a photochromic material, is then encapsulated in a container 30 via two holes 31. The container 30 is substantially transparent, thin, and made of plastic. The holes 31 are defined in the container 30. In an alternative embodiment, the number of the hole(s) 31 could be one, three or more. The color-changeable material fills the container 30 completely. The holes 31 are plugged by using, for example, a glue/adhesive. In alternative embodiments, the container 30 could be of other shape as long as it can receive color-changeable material therein and fit with other parts of the portable electronic device. The container 30 containing the color-changeable material is adhered to the front cover 11 and the rear cover 12, thereby forming a color changing layer 22. Finally, transparent paint serving as a surface paint is sprayed onto the mobile phone 10 by using a spray gun. The paint of the mobile phone 10 is hardened by using, for example, heat treatment hardening or ultra-violet (UV) hardening, thereby forming a surface paint layer 23. Thus, the mobile phone 10 can be given a color-change function.

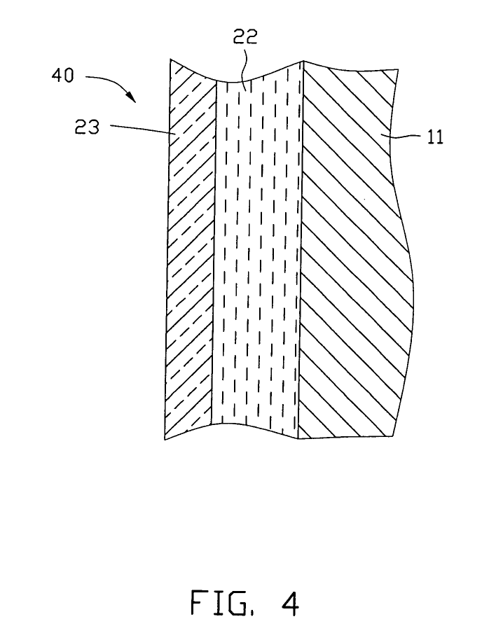

Referring to FIG. 4, a multilayer structure 40 according to a second embodiment of the present invention is shown. The multilayer structure 40 of the second embodiment is similar to the multilayer structure 20 of the first embodiment, except that the primer layer 21 could be omitted. The container 30 containing the color-changeable material is adhered to the front cover 11 and the rear cover 12 directly, thereby forming a color changing layer 22. The spray gun sprays the transparent paint as for surface paint over the mobile phone 10, thereby forming a surface paint layer 23.

Compared with a typical mobile phone, the present mobile phone 10 has the following advantages. Firstly, the multilayer structure 20 means that the user may easily change colors of the first cover 11 or the rear cover 12 according to his or her fancy due to the color changing layer 22. Secondly, the color-changeable material is encapsulated in the container 30, the container 30 is substantially transparent, thin, and made of plastic, thus, the container 30 could be adhered to any outer portion of the mobile phone 10. Finally, the user may design a shape of the container 30 for achieving a patterned color-change area.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device, comprising:
a frame; and
a color changing layer coated onto the frame;
wherein the color changing layer contains a color-changeable material.

2. The portable electronic device as claimed in claim 1, wherein the frame further includes a primer layer, and the color changing layer is coated onto the primer layer.

3. The portable electronic device as claimed in claim 1, wherein the frame further includes a surface paint layer, the surface paint layer is coated onto the color changing layer.

4. The portable electronic device as claimed in claim 1, wherein the color changing layer includes a container adhered to the frame, the color-changeable material is encapsulated in the container, and the color-changeable material is selected from the group consisting of thermochromic and photochromic materials.

5. The portable electronic device as claimed in claim 4, wherein the container is transparent, thin, and made of plastic, the container includes a hole via which the color-changeable material is received therein.

6. A method of manufacturing a portable electronic device, comprising the steps of:
providing a frame of the portable electronic device;
providing a container containing a color-changeable material therein; and
attaching the container to the frame.

7. The method of manufacturing a portable electronic device as claimed in claim 6, including a further step of spraying a primer over the mobile phone.

8. The method of manufacturing a portable electronic device as claimed in claim 7, including a further step where the primer is hardened by using a treatment chosen from the group consisting of heat treatment hardening and ultra-violet hardening.

9. The method of manufacturing a portable electronic device as claimed in claim 6, including a further step of providing a transparent paint, the paint being sprayed over the mobile phone.

10. The method of manufacturing a portable electronic device as claimed in claim 9, including a further step of hardening the paint using a treatment chosen from the group consisting of heat treatment hardening and ultra-violet hardening.

11. The method of manufacturing a portable electronic device as claimed in claim 6, wherein the container is transparent, thin, and made of plastic, the container includes a hole.

12. A portable electronic device, comprising:
a frame configured for housing electronic components therein; and
a color changing layer formed on the frame, the color changing layer comprising a transparent body, and a color material received in the transparent body, the color material being capable of automatically changing color in response to environmental variations.

13. The portable electronic device as claimed in claim 12, wherein the color material is chosen from the group consisting of thermochromic and photochromic materials.
